(19) United States
(12) Patent Application Publication
(10) Pub. No.: US 2021/0082331 A1
(43) Pub. Date: Mar. 18, 2021

(54) ELECTRONIC DEVICE

(71) Applicant: Innolux Corporation, Miao-Li County (TW)

(72) Inventors: Chun-Fu Wu, Miao-Li County (TW); Wen-Tsai Hsu, Miao-Li County (TW); Sheng-Feng Huang, Miao-Li County (TW)

(73) Assignee: Innolux Corporation, Miao-Li County (TW)

(21) Appl. No.: 17/004,033

(22) Filed: Aug. 27, 2020

(30) Foreign Application Priority Data
Sep. 18, 2019 (CN) 201910881389.8

(51) Int. Cl. G09G 3/20

(52) U.S. Cl. CPC G09G 3/20; G09G 2310/08; G09G 2310/0281; G09G 2310/0202; G09G 2310/0267

(57) ABSTRACT

The disclosure provides an electronic device including a panel. The panel includes a display area, a first peripheral area and a plurality of driving units. The display area includes a plurality of odd-numbered gate lines and a plurality of even-numbered gate lines. The first peripheral area is disposed adjacent to the display area. The driving units are disposed in the first peripheral area and include a first driving unit group and a second driving unit group. The first driving unit group includes N driving units which correspond to N gate lines among first 2N of the odd-numbered gate lines or to N gate lines among first 2N of the even-numbered gate lines, wherein N is a positive integer greater than 1. The second driving unit group is disposed adjacent to the first driving unit group and includes 2P driving units which respectively correspond to P odd-numbered gate lines and P even-numbered gate lines.

### CROSS-REFERENCE TO RELATED APPLICATION

This application claims the priority benefit of China application serial no. 201910881389.8, filed on Sep. 18, 2019. The entirety of the above-mentioned patent application is hereby incorporated by reference herein and made a part of this specification.

### BACKGROUND

### Technical Field

The disclosure relates to an electronic device, and more particularly to an electronic device with a display panel.

### Description of Related Art

With the evolution of the manufacturing technology of electronic devices (such as display panels), the gate driving circuit may be manufactured on a glass substrate (gate on panel, GOP) of a display panel. However, the electronic devices with this configuration still have a problem of poor display quality and need to be improved.

### SUMMARY

The disclosure provides an electronic device, which may provide a good display effect.

The electronic device of the disclosure includes a display panel (for the sake of simple description, the “display panel” is simply referred to as the “panel” in the following descriptions). The panel includes a display area, a first peripheral area, and a plurality of driving units. The display area includes a plurality of odd-numbered gate lines and a plurality of even-numbered gate lines. The first peripheral area is disposed adjacent to the display area. The plurality of driving units are disposed in the first peripheral area. The plurality of driving units include a first driving unit group and a second driving unit group. The first driving unit group includes N driving units. The N driving units correspond to N gate lines among first 2N of the plurality of odd-numbered gate lines or to N gate lines among first 2N of the plurality of even-numbered gate lines, wherein N is a positive integer greater than 1. The second driving unit group is disposed adjacent to the first driving unit group and includes 2P driving units. The 2P driving units respectively correspond to P odd-numbered gate lines and P even-numbered gate lines.

Based on the above, in the electronic device of the disclosure, the secondary coupling problem in the driving process of the display units of the electronic device may be reduced by a specific driving unit arrangement sequence. Therefore, the electronic device of the disclosure may provide a good display effect.

In order to make the aforementioned features and advantages of the disclosure comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electronic device according to an embodiment of the disclosure.

FIG. 2 is a schematic diagram of a part of a display unit array of an electronic device according to an embodiment of the disclosure.

FIG. 3 is a schematic diagram of an arrangement of a plurality of driving units according to an embodiment of the disclosure.

FIG. 4 is a schematic diagram of an arrangement of a plurality of driving units according to another embodiment of the disclosure.

FIG. 5 is a schematic diagram of an arrangement of a plurality of driving units according to still another embodiment of the disclosure.

FIG. 6 is a schematic diagram of another embodiment of the first peripheral area and the second peripheral area in FIG. 3 according to the disclosure.

FIG. 7 is a waveform timing diagram of a plurality of clock signals of a plurality of driving units in the first peripheral area according to the embodiment of FIG. 6.

### DESCRIPTION OF THE EMBODIMENTS

In the disclosure, the same or similar elements will be denoted by the same or similar reference numerals, and repeated descriptions thereof will be omitted. In addition, as long as the features in different embodiments do not violate or conflict with the spirit of the disclosure, they may be arbitrarily combined, replaced, mixed or matched, and simple equivalent changes and modifications made in accordance with the specification or claims are still within the scope of the disclosure. In the description of the disclosure and the appended claims, certain terms will be used to refer to specific elements. Persons of ordinary skill in the art would understand that electronic device manufacturers may refer to the same elements under different names. This disclosure does not intend to distinguish between elements that have the same functions but different names.

In the claims and the following description, the words “including,” “comprising” and “having” are open-ended terms and should be interpreted as meaning “including but not limited to.”

In addition, the terms “first” and “second” mentioned in the specification or claims are only used to name discrete elements or to distinguish different embodiments or ranges, and are not intended to indicate the upper limit or the lower limit of the number of elements, nor are they intended to limit the manufacturing order or disposition order of the elements. The same terms may not be used in the claims and may be replaced with “first,” “second,” “third” and the like in the order in which the elements are declared in the claims. Accordingly, a first member in the following description may be a second member in the claims.

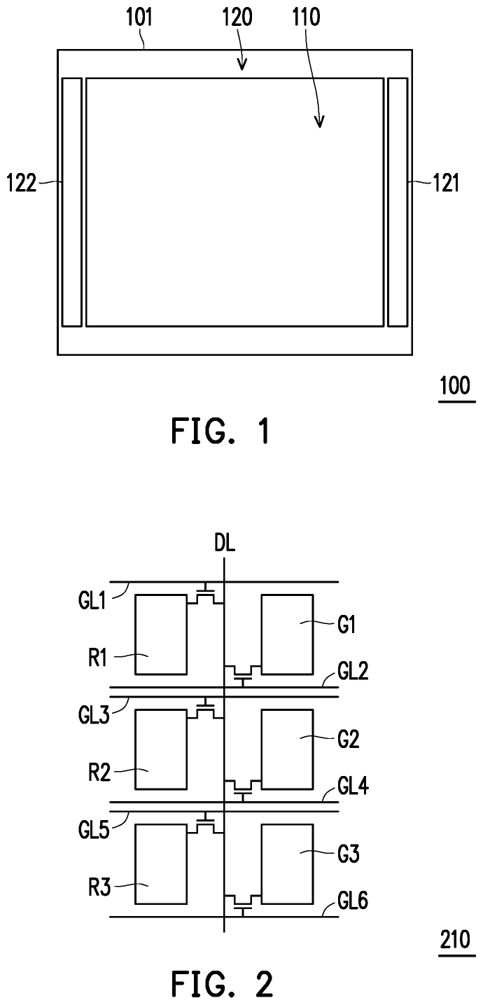

FIG. 1 is a schematic diagram of an electronic device according to an embodiment of the disclosure. With reference to FIG. 1, an electronic device 100 includes a panel 101, and the panel 101 includes a display area 110, a periphery 120 which includes a first peripheral area 121 and a second peripheral area 122 disposed adjacent to the display area 110. In the disclosure, the first peripheral area 121 and the second peripheral area 122 may be disposed around the display area 110, for example. The display area 110 may further include a plurality of display units (not shown) arranged in an array. The substrate used in the panel 101 may be, for example, a hard substrate or a soft flexible substrate, but it is not limited to the above. For example, in the disclosure, the hard substrate may be, for example, a glass substrate, a quartz substrate or a sapphire substrate, and the soft flexible substrate may be, for example, a polyimide (PI) substrate, a polycarbonate (PC) substrate, a polyethylene terephthalate (PET) substrate, or the like. In the disclosure, the electronic device 100 may be any kind of displays that may present images, such as a liquid crystal display (LCD), an organic light emitting diode display (OLED display), an inorganic light emitting diode display (LED display), a mini light emitting diode display (mini-LED display), a micro light emitting diode display (micro-LED display), a quantum-dot light emitting diode display (QLED display), an electro-phoretic display (EPD) or the like, but it not limited to the above. In the disclosure, a plurality of driving units may be formed directly on the first peripheral area 121 and the second peripheral area 122 of the periphery 120 of the panel 101 to reduce the number of integrated circuits (ICs) used in the panel 101 or to achieve the effect of narrow borders. The plurality of driving units may be coupled to a plurality of gate lines in the display area 110 to drive the plurality of display units in the display area 110. In addition, the panel 101 of the disclosure is not limited to the shape shown in FIG. 1, therefore, in other embodiments, the number and the positions of the peripheral areas may be determined according to the shapes of the panels 101 or the display areas 110.

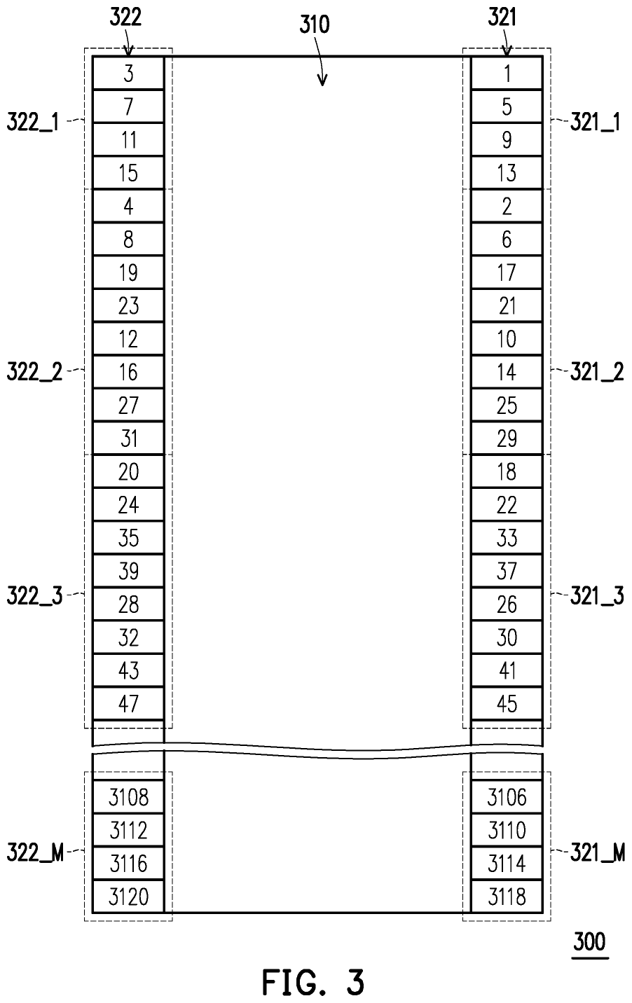

FIG. 2 is a schematic diagram of a part of a display unit array of an electronic device according to an embodiment of the disclosure. With reference to FIG. 1 and FIG. 2, the display unit array in the display area 110 shown in FIG. 1 may adopt a “half data line and double gate line” (HDDG) configuration, and a part of the display unit array may be the display unit array 210 as shown in FIG. 2. In FIG. 2, display units R1, R2 and R3 in the first column and display units G1, G2 and G3 in the second column of the display unit array 210 are coupled to the same data line DL. The display units R1, R2 and R3 in the first column are respectively coupled to gate lines (which may also be referred to as scan lines) GL1, GL3 and GL5. The display units G1, G2 and G3 in the second column are respectively coupled to gate lines GL2, GL4 and GL6. However, if the gate lines GL1 to GL6 are driven sequentially, the display units R1 to R3 and G1 to G3 will have a problem of double coupling. For example, after the gate line GL1 first receives a driving signal to drive the display unit R1, if the gate line GL2 then receives a driving signal to drive the display unit G1, since the gate lines GL1 and GL2 are both adjacent to the display unit R1, it causes the display unit R1 to be influenced by the coupling capacitance between the display unit R1 and the gate line GL2 before the driving function of the gate line GL1 ends. In other words, the result image of the display unit R1 will be influenced by the driving signal of the gate line GL2. In this regard, the disclosure may effectively separate the timing of driving the gate lines GL1 to GL6 by modifying the coupling sequence between the driving units and the gate lines GL1 to GL6. In the following, several modified embodiments of FIGS. 3 to 6 will be described in detail.

FIG. 3 is a schematic diagram of an arrangement of a plurality of driving units according to an embodiment of the disclosure. With reference to FIG. 3, a first peripheral area 321 and a second peripheral area 322 are on both sides outside a display area 310 of an electronic device 300, and there may be a plurality of driving units in the first peripheral area 321 and the second peripheral area 322. In this embodiment, there may be a plurality of driving unit groups 321_1 to 321_M in the first peripheral area 321, and a plurality of driving unit groups 322_1 to 322_M in the second peripheral area 322, wherein M is a positive integer greater than 1. For example, the first driving unit group 321_1 in the first peripheral area 321 includes four driving units, and the four driving units correspond to four gate lines among the first eight of the odd-numbered gate lines of the electronic device 300. As shown in FIG. 3, the four driving units may be sequentially coupled to the 1st gate line (1), the 5th gate line (5), the 9th gate line (9), and the 13th gate line (13) of the electronic device 300. The driving unit groups 321_1 to 321_M and the driving unit groups 322_1 to 322_M respectively drive a plurality of display units in the display area 310 through the corresponding gate lines. The arrangement and coupling method of the display units may be inferred from the coupling method of the part of the display unit array of FIG. 2 as described above, but this embodiment is not limited to FIG. 2. For example, the number of display units to which each gate line is coupled may be changed according to the actual design. In addition, in this embodiment, the last gate line corresponding to the driving unit is the 3120th gate line (3120), but the total number of the gate lines may be changed according to the actual design.

Moreover, the number of driving units in the first driving unit group 321_1 in the first peripheral area 321 of the disclosure is not limited to FIG. 3. In an embodiment, the first driving unit group 321_1 may include N driving units, and the N driving units correspond to N gate lines among the first 2N of the odd-numbered gate lines or to N gate lines among the first 2N of the even-numbered gate lines, wherein N is a positive integer greater than 1. In another embodiment, N is greater than 2 and less than or equal to 8 (2<N≤8).

Furthermore, the second driving unit group 321_2 in the first peripheral area 321 includes eight driving units, and the eight driving units correspond to eight gate lines in the electronic device 300. As shown in FIG. 3, the eight driving units are, for example, sequentially coupled to the 2nd gate line (2), the 6th gate line (6), the 17th gate line (17), the 21st gate line (21), the 10th gate line (10), the 14th gate line (14), the 25th gate line (25) and the 29th gate line (29) of the electronic device 300. That is, the driving unit group 321_2 includes four odd-numbered gate lines and four even-numbered gate lines.

It should be noted that the number of driving units included in the second driving unit group is not limited to the embodiment of FIG. 3. In an embodiment, the second driving unit group 321_2 may include 2P driving units, and the 2P driving units respectively correspond to P odd-numbered gate lines and P even-numbered gate lines, wherein P is a positive integer greater than 1. In another embodiment, P is greater than 2 and less than or equal to 8. In the following description of the disclosure, an example in which P is equal to 4 is described.

The third driving unit group 321_3 in the first peripheral area 321 is disposed beside the second driving unit group 321_2 so that the second driving unit group 321_2 is located between the first driving unit group 321_1 and the third driving unit group 321_3. Similar to the second driving unit group, the third driving unit group 321_3 also includes eight driving units (P is equal to 4), and the eight driving units correspond to eight gate lines in the electronic device 300. As shown in FIG. 3, the eight driving units are, for example, sequentially coupled to the 18th gate line (18), the 22nd gate line (22), the 33rd gate line (33), the 37th gate line (37), the 26th gate line (26), the 30th gate line (30), the 41st gate line (41) and the 45th gate line (45) of the electronic device 300. That is, the driving unit group 321_3 also includes four odd-numbered gate lines and four even-numbered gate lines. In addition, each gate line corresponds to a driving unit, the gate line corresponding to a driving unit at a position of the driving unit group 321_2 is separated from the gate line corresponding to the driving unit at a corresponding position of the driving unit group 321_3 by 15 gate lines.

For example, the second driving unit of the second driving unit group 321_2 corresponds to the 6th gate line (6), and the second driving unit of the third driving unit group 321_3 corresponds to the 22nd gate line (22), and the two are separated by 15 gate lines (the 7th to the 21st gate lines).

More specifically, when the number of driving units in the second driving unit group 321_2 and the third driving unit group 321_3 is 2P, the gate line corresponding to a driving unit at a position of the second driving unit group 321_2 is separated from the gate line corresponding to the driving unit at a corresponding position of third driving unit group 321_3 by (4P−1) gate lines.

By analogy, the corresponding gate lines of the driving unit group 321_4 to the driving unit group 321_(M−1) may have the same coupling rule, which will not be repeated herein. Moreover, in this embodiment, the number of driving units included in the last driving unit group 321_M is equal to the number of driving units included in the first driving unit group 321_1. For example, as shown in FIG. 3, the number of driving units included in the first driving unit group 321_1 and the number of driving units included in the last driving unit group 321_M are both four. In addition, in this embodiment, all driving units in the first driving unit group 321_1 correspond to odd-numbered gate lines, and all driving units in the last driving unit group 321_M correspond to even-numbered gate lines. On the contrary, in one embodiment, if all the driving units in the first driving unit group 321_1 correspond to even-numbered gate lines, then all the driving units in the last driving unit group 321_M correspond to odd-numbered gate lines.

Similarly, the coupling rules of the driving unit groups 322_1 to 322_M of the second peripheral area 322 may be inferred from the driving unit groups 321_1 to 321_M in the first peripheral area 321, which will not be repeated herein. The coupling sequence of the plurality of driving units and the plurality of gate lines in the first peripheral area 321 and the second peripheral area 322 is a staggered configuration. For example, when the first driving unit group 321_1 in the first peripheral area 321 corresponds to the N odd-numbered gate lines in the first 2N of the plurality of odd-numbered gate lines, the first driving unit group 322_1 of the second peripheral area 322 corresponds to the other N odd-numbered gate lines in the first 2N of the plurality of odd-numbered gate lines.

Therefore, based on the coupling sequence of the driving unit groups 321_1 to 322_M in the first peripheral area 321 and the individual gate lines, and based on the coupling sequence of the second peripheral area 322 and the individual gate lines, the electronic device 300 of this embodiment may effectively separate the driving timing of each gate line. For example, after the 1st driving unit (1) drives the 1st gate line, the 5th driving unit (5) drives the 5th gate line. In other words, since the 2nd gate line is not driven right after the 1st gate line, the display unit coupled to the 1st gate line is not affected by the driving signal of the adjacent 2nd gate line. Therefore, the electronic device 300 of the embodiment may reduce the problem of secondary coupling of the display units of the electronic device 300.

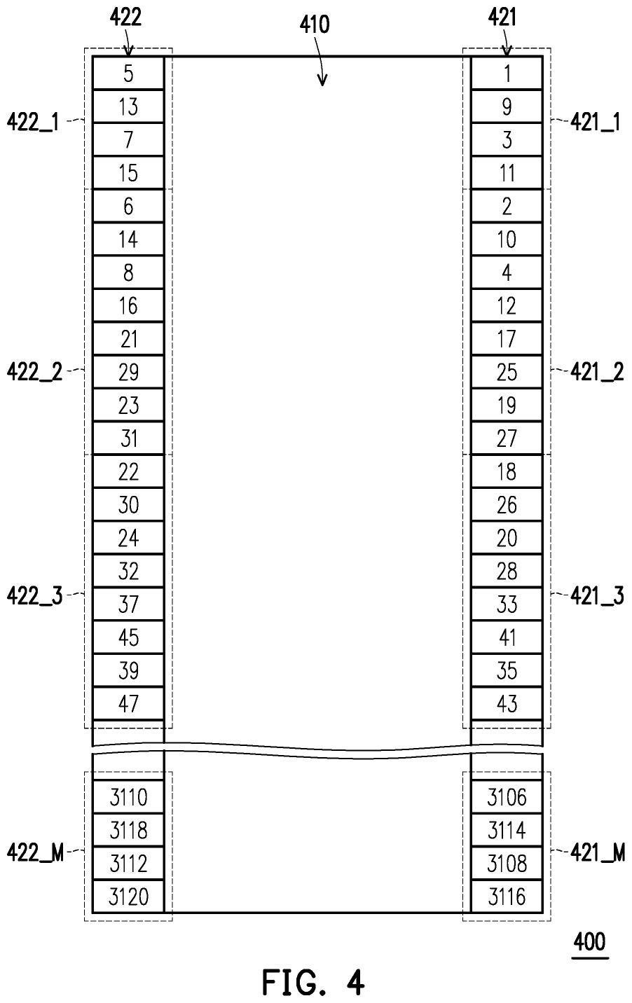

FIG. 4 is a schematic diagram of an arrangement of a plurality of driving units according to another embodiment of the disclosure. With reference to FIG. 4, a first peripheral area 421 and a second peripheral area 422 on both sides outside a display area 410 of an electronic device 400, and there may be respectively a plurality of driving units in the first peripheral area 421 and a second peripheral area 422. In addition, the difference between this embodiment and the embodiment shown in FIG. 3 is that in the two first driving unit groups 421_1 and 422_1 and the last two driving unit groups 421_M and 422_M of this embodiment, the sequence that the gate line corresponds to a driving unit is not as regular as the embodiment shown in FIG. 3. For example, in FIG. 3, the gate lines corresponding to the driving units of the first driving unit group 321_1 are in an ascending sequence (the 1st, the 5th, the 9th, and the 13th gate lines sequentially), and the interval is the same (two corresponding gate lines are separated by three gate lines), but in the first driving unit group 421_1 of this embodiment, the sequence of the driving units does not exhibit similar regular changes.

Although the coupling sequence of the plurality of driving unit groups 421_1 to 421_M in the first peripheral area 421 and the plurality of driving unit groups 422_1 to 422_M in the second peripheral area 422 and the gate lines in FIG. 4 is different from the embodiment in FIG. 3, the problem of secondary coupling of each display unit may also be reduced.

In detail, as shown in FIG. 4, the first driving unit group 421_1 in the first peripheral area 421 includes four driving units which are sequentially coupled to the 1st gate line (1), the 9th gate line (9), the 3rd gate line (3) and the 11th gate line (11) of the electronic device 400. The second driving unit group 421_2 in the first peripheral area 421 includes eight driving units which are sequentially coupled to the 2nd gate line (2), the 10th gate line (10), the 4th gate line (4), the 12th gate line (12), the 17th gate line (17), the 25th gate line (25), the 19th gate line (19) and the 27th gate line (27) of the electronic device 400. The third driving unit group 421_3 in the first peripheral area 421 includes eight driving units which are sequentially coupled to the 18th gate line (18), the 26th gate line (26), the 20th gate line (20), the 28th gate line (28), the 33rd gate line (33), the 41st gate line (41), the 35th gate line (35) and the 43rd gate line (43) of the electronic device 400. All driving units in the first driving unit group 421_1 in the first peripheral area 421 correspond to odd-numbered gate lines, and all driving units in the last driving unit group 421_M correspond to even-numbered gate lines. Similarly, the coupling rules of the driving unit groups 422_1 to 422_M of the second peripheral area 422 and the plurality of gate lines may be inferred from the driving unit groups 421_1 to 421_M in the first peripheral area 421.

That is, in the embodiment, the four driving units in the first driving unit group 421_1 in the first peripheral area 421 similarly correspond to four gate lines among the first eight of the odd-numbered gate lines of the electronic device 400. The driving unit groups 421_2 and 421_3 also include four odd-numbered gate lines and four even-numbered gate lines. The gate line corresponding to a driving unit at a position of the driving unit group 421_2 is separated from the gate line corresponding to the driving unit at a corresponding position of driving unit group 421_3 by 15 gate lines. In addition, all driving units in the first driving unit group 421_1 correspond to odd-numbered gate lines, and all driving units in the last driving unit group 421_M correspond to even-numbered gate lines. Therefore, the electronic device 400 of the embodiment may also reduce the problem of secondary coupling of the display units of the electronic device 400.

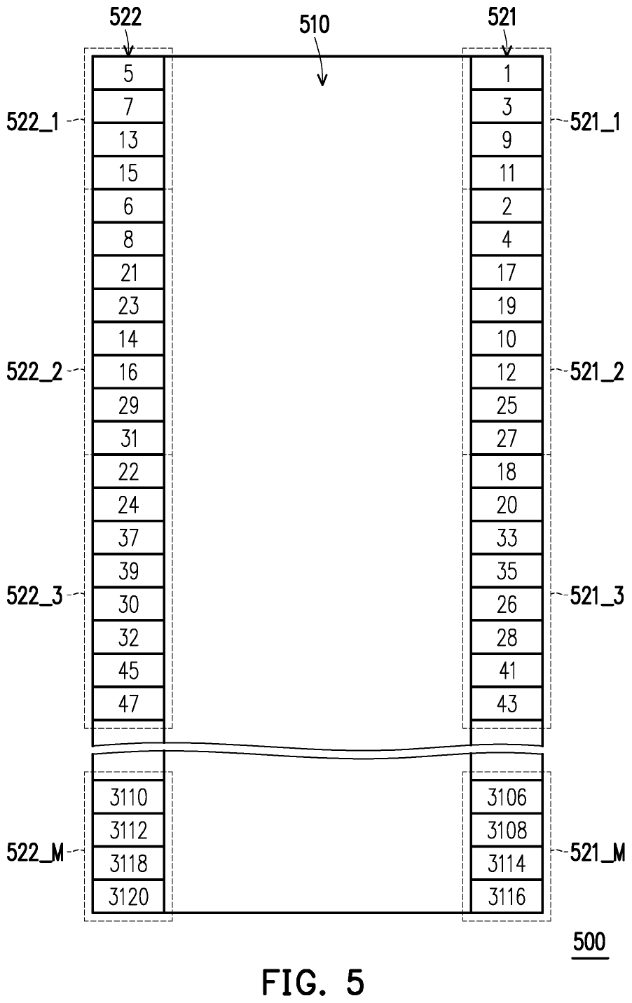

FIG. 5 is a schematic diagram of an arrangement of a plurality of driving units according to still another embodiment of the disclosure. With reference to FIG. 5, a first peripheral area 521 and a second peripheral area 522 on both sides outside a display area 510 of an electronic device 500, and there may be respectively a plurality of driving units in the first peripheral area 521 and a second peripheral area 522. Although the coupling sequence of the plurality of driving unit groups 521_1 to 521_M in the first peripheral area 521 and the plurality of driving unit groups 522_1 to 522_M of the second peripheral area 522 and the gate lines in FIG. 5 is different from the embodiment in FIG. 3, the problem of secondary coupling of display units may also be reduced.

In detail, as shown in FIG. 5, the first driving unit group 521_1 in the first peripheral area 521 includes four driving units which are sequentially coupled to the 1st gate line (1), the 3rd gate line (3), the 9th gate line (9) and the 11th gate line (11) of the electronic device 500. The second driving unit group 521_2 in the first peripheral area 521 includes eight driving units which are sequentially coupled to the 2nd gate line (2), the 4th gate line (4), the 17th gate line (17), the 19th gate line (19), the 10th gate line (10), the 12th gate line (12), the 25th gate line (25) and the 27th gate line (27) of the electronic device 500. The third driving unit group 521_3 in the first peripheral area 521 includes eight driving units which are sequentially coupled to the 18th gate line (18), the 20th gate line (20), the 33rd gate line (33), the 35th gate line (35), the 26th gate line (26), the 28th gate line (28), the 41st gate line (41) and the 43rd gate line (43) of the electronic device 500. All driving units in the first driving unit group 521_1 in the first peripheral area 521 correspond to odd-numbered gate lines, and all driving units in the last driving unit group 521_M correspond to even-numbered gate lines. Similarly, the rules of the driving unit groups 522_1 to 522_M of the second peripheral area 522 may be inferred from the driving unit groups 521_1 to 521_M in the first peripheral area 521.

That is, in the embodiment, the four driving units in the first driving unit group 521_1 in the first peripheral area 521 similarly correspond to four gate lines among the first eight of the odd-numbered gate lines of the electronic device 500. The driving unit groups 521_2 and 521_3 also include four odd-numbered gate lines and four even-numbered gate lines. The gate line corresponding to a driving unit at a position of the driving unit group 521_2 is separated from and the gate line corresponding to the driving unit at a corresponding position of the driving unit group 521_3 by 15 gate lines. In addition, all driving units in the first driving unit group 521_1 correspond to odd-numbered gate lines, and all driving units in the last driving unit group 521_M correspond to even-numbered gate lines. Therefore, the electronic device 500 of the embodiment may also reduce the problem of secondary coupling of the display units of the electronic device 500.

However, the coupling sequence of the driving units and the gate lines of the disclosure is not limited to the above-described modified embodiments of FIGS. 3 to 5. The coupling sequence of the driving units and the gate lines of the disclosure may also be inferred based on the same coupling rules corresponding to the above-described FIGS. 3 to 5.

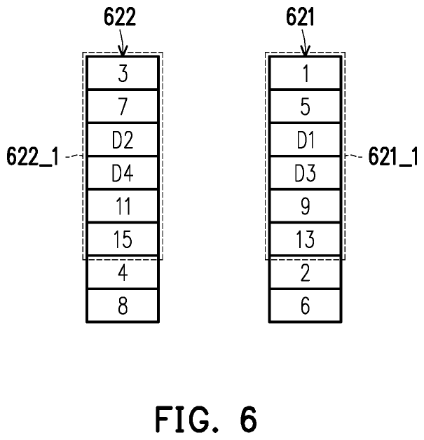

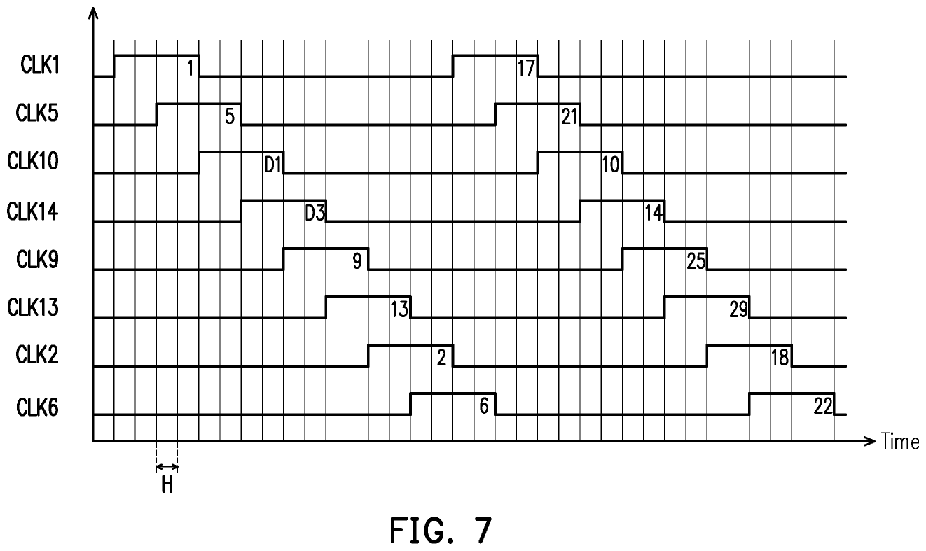

FIG. 6 is a schematic diagram of another embodiment of the first peripheral area and the second peripheral area in FIG. 3 according to the disclosure. FIG. 7 is a waveform timing diagram of a plurality of clock signals of a plurality of driving units in the first peripheral area according to the embodiment of FIG. 6. With reference to first to FIG. 6, FIG. 6 is another embodiment of the first driving unit groups 321_1 and 322_1 in the first peripheral area 321 and the second peripheral area 322 of the embodiment of FIG. 3. In the embodiment, a first driving unit group 621_1 of a first peripheral area 621 may include six driving units which are sequentially coupled to the 1st gate line (1), the 5th gate line (5), a dummy gate line (D1), a dummy gate line (D3), the 9th gate line (9), and 13th gate line (13). The first driving unit group 622_1 of the second peripheral area 622 may also include six driving units which are sequentially coupled to the 3rd gate line (3), the 7th gate line (7), a dummy gate line (D2), a dummy gate line (D4), the 11th gate line (11), and 15th gate line (15). Here, the dummy gate line is a gate line that does not exist. In other words, compared with the first driving unit group 321_1 in FIG. 3, the first driving unit group 621_1 of this embodiment may further include two redundant driving units (D1 and D3) that are not coupled to any gate lines, and similarly, the first driving unit group 622_1 may also include two redundant driving units (D2 and D4) that are not coupled to any gate lines. Further, in this embodiment, the total number of redundant driving units is not limited to four, and their locations may be within the first driving unit groups 621_1 and 622_1, or between the first driving unit groups 621_1 and/or 622_1 and the second driving unit groups 621_2 and/or 622_2. In addition, other driving unit groups in the first peripheral area 621 and the second peripheral area 622 are the same as those in the above-described embodiment of FIG. 3, and the details are not repeated herein.

Then, with reference to FIG. 7, the driving timing of the plurality of driving units in the first peripheral area 621 may be exemplified as eight clock signals CLK1, CLK5, CLK10, CLK14, CLK9, CLK13, CLK2 and CLK6, but it not limited to the above. In addition, it is first explained that the primary driving cycle of each display unit of the electronic device of this embodiment is four unit times 4H, and one unit time H is equivalent to the primary charging time of the display unit, but the relationship between the driving cycle and the charging time of the display unit is not limited to the above. In this embodiment, the driving unit in the first driving unit group 621_1 corresponding to the 1st gate line (1) may receive the clock signal CLK1 to turn on the display unit coupled to the 1st gate line (1), whereby the display unit may be charged. Then, after an interval of two unit times 2H, the driving unit corresponding to the 1st gate line (1) may provide a clock signal CLK5 to the following driving unit corresponding to the 5th gate line (5) to turn on the display unit coupled to the 5th gate line (5). Then, after an interval of two unit times 2H, the driving unit corresponding to the 5th gate line (5) may provide the clock signal CLK10 to the following redundant driving unit (D1). Since the redundant driving unit (D1) is not coupled to any gate line, no corresponding display unit is turned on. However, after two unit times 2H, the redundant driving unit (D1) continues to provide the clock signal CLK14 to the following driving unit. By analogy with the above signal transmission methods, the clock signals CLK9 and CLK13 may be sequentially provided to the following other driving units of the first driving unit group 621_1, and then the clock signals CLK2, CLK6 and the like may be sequentially provided to the driving units in second driving unit group 621_2 corresponding to the 2nd gate line (2) and the 6th gate line (6). In other words, the coupling sequence of the driving units of this embodiment may effectively separate the driving timing of the gate lines.

It should be noted that in the disclosure, the transmission method of the clock signals is not limited to the above method. In some modified embodiments, the driving unit in the first driving unit group 621_1 corresponding to the 1st gate line (1) may receive the clock signal CLK1, while the driving unit corresponding to the 5th gate line (5) may receive the clock signal CLK5. Then, after an interval of four unit times 4H, the driving unit corresponding to the 1st gate line (1) may provide the clock signal CLK10 to the redundant driving unit (D1), and after another four unit times 4H, the redundant driving unit (D1) provides the clock signal CLK9 to the driving unit corresponding to the 9th gate line (9). Thereafter, after an interval of four unit times 4H, the driving unit continues to provide the clock signal to the following driving units, and completes the transmission of the clock signals in the same regular way. Similarly, the driving unit corresponding to the 5th gate line (5) may provide the clock signal CLK14 to the redundant driving unit (D3), and after four unit times 4H, the redundant driving unit (D3) provides the clock signal CLK13 to the driving unit corresponding to the 13th gate line (13), and after every four unit times 4H, the clock signal continues to be transmitted to the following driving units, and the transmission of the clock signals is completed in the same regular way. That is, in this modified embodiment, the clock signal of the driving unit is transmitted to the second following driving unit after an interval of four unit times 4H, and the first following driving unit between the driving unit and the second following is ignored. However, the above-described transmission method is only a modified example, and any reasonable clock signal transmission method may fall within the scope of the disclosure.

Furthermore, in FIG. 7, the driving unit corresponding to the 2nd gate line (2) adjacent to the 1st gate line (1) receives the clock signal CLK2 at the time when the charging of the display unit coupled to the 1st gate line (1) has been completed. Therefore, although the 2nd gate line (2) receiving the clock signal CLK2 influences the display unit coupled to the 1st gate line (1), since the charging of the display unit coupled to the 1st gate line has been completed, even if it is influenced by the rising edge (charging) and falling edge (discharging) of the clock signal CLK2, the influence of the rising edge and falling edge of the clock signal CLK2 will be offset. In other words, the aforementioned secondary coupling phenomenon is less likely to occur. Therefore, the electronic device of the embodiment may provide a good display quality.

In addition, since the clock signals CLK1, CLK5, CLK10, CLK14, CLK9, CLK13, CLK2 and CLK6 of this embodiment may be sequentially provided at a fixed length of time interval (two unit times 2H), the clock signals and the charging times received by the driving unit may have substantially the same regularity. In this way, the driving signals output by the driving units to the gate lines are substantially uniform, which may improve the display quality of the electronic device.

In addition, even if in the above-described embodiment of FIG. 3 in which there is no redundant driving unit, it may be inferred from FIG. 7 that the driving timing of each gate line may be effectively separated by adjusting the coupling sequence of the driving units. Furthermore, in the embodiment of FIG. 3, the driving unit corresponding to the 2nd gate line (2) receives the clock signal CLK2 at the time when the charging of the display unit coupled to the 1st gate line (1) has been completed. Therefore, the coupling sequence of the driving units in the embodiment of FIG. 3 may also effectively separate the driving timing of each gate line, thereby reducing the situation of poor display quality caused by the secondary coupling phenomenon. Moreover, the embodiments of FIG. 4 and FIG. 5 may be deduced by analogy.

In summary of the above, in the electronic device of the disclosure, the secondary coupling problem in the driving process of the display units of the electronic device may be reduced by a specific driving unit arrangement sequence. In addition, since the clock signal and the charging time received by each driving unit in the embodiment may have substantially the same regularity, the driving signals output by the driving units to the gate lines may also be substantially uniform. Therefore, the electronic device of the disclosure may provide a good display quality.

Furthermore, it should be noted that the above embodiments are only used to illustrate the technical solutions of the disclosure and are not intended to limit it. Although the disclosure has been described in detail with reference to the above embodiments, persons of ordinary skill in the art should understand that they may still modify or combine the technical solutions described in the above embodiments, or replace some or all of the technical features therein with equivalents, and that combinations, modifications, or replacements of corresponding technical solutions do not substantially deviate from the scope of the technical solutions of the embodiments of the disclosure.

What is claimed is:

1. An electronic device comprising:
a panel comprising:
a display area comprising a plurality of odd-numbered gate lines and a plurality of even-numbered gate lines;
a first peripheral area disposed adjacent to the display area; and
a plurality of driving units disposed in the first peripheral area, the plurality of driving units comprising:
a first driving unit group comprising N driving units, wherein the N driving units correspond to N gate lines among first 2N of the plurality of odd-numbered gate lines or to N gate lines among first 2N of the plurality of even-numbered gate lines, wherein N is a positive integer greater than 1; and
a second driving unit group disposed adjacent to the first driving unit group and comprising 2P driving units, wherein the 2P driving units respectively correspond to P of the plurality of odd-numbered gate lines and P of the plurality of even-numbered gate lines.

2. The electronic device according to claim 1, wherein N is greater than 2 and less than or equal to 8, and P is greater than 2 and less than or equal to 8.

3. The electronic device according to claim 1, wherein the plurality of driving units further comprise:
a third driving unit group disposed adjacent to the second driving unit group and comprising 2P driving units, wherein the 2P driving units respectively correspond to P of the plurality of odd-numbered gate lines and P of the plurality of even-numbered gate lines,
wherein a gate line corresponding to a driving unit at a position of the second driving unit group is separated from a gate line corresponding to a driving unit at a corresponding position of the third driving unit group by (4P−1) gate lines.

4. The electronic device according to claim 3, wherein the second driving unit group is located between the first driving unit group and the third driving unit group.

5. The electronic device according to claim 1, wherein the plurality of driving units further comprise:
a last driving unit group, wherein a number of driving units comprised in the last driving unit group is equal to a number of driving units comprised in the first driving unit group.

6. The electronic device according to claim 5, wherein when all driving units in the first driving unit group correspond to odd-numbered gate lines, all driving units in the last driving unit group correspond to even-numbered gate lines.

7. The electronic device according to claim 5, wherein when all driving units in the first driving unit group correspond to even-numbered gate lines, all driving units in the last driving unit group correspond to odd-numbered gate lines.

8. The electronic device according to claim 1, wherein the panel further comprises:
a redundant driving unit disposed in the first peripheral area,
wherein the redundant driving unit is disposed between the first driving unit group and the second driving unit group or is disposed within the first driving unit group.

9. The electronic device according to claim 1, wherein the panel comprises:
a substrate, wherein the plurality of driving units are formed on the substrate.

10. The electronic device according to claim 1, wherein the panel comprises:
a second peripheral area disposed adjacent to the display area; and
another plurality of driving units disposed in the second peripheral area, the another plurality of driving units comprising:
another first driving unit group comprising another N driving units, wherein the another N driving units correspond to other N gate lines among the first 2N of the plurality of odd-numbered gate lines or to other N gate lines among the first 2N of the plurality of even-numbered gate lines, wherein N is a positive integer greater than 1.

11. The electronic device according to claim 10, wherein the another plurality of driving units comprise:
another second driving unit group disposed adjacent to the another first driving unit group and comprising other 2P driving units, wherein the other 2P driving units respectively correspond to other P odd-numbered gate lines and other P even-numbered gate lines.

12. The electronic device according to claim 11, wherein N is greater than 2 and less than or equal to 8, and P is greater than 2 and less than or equal to 8.

13. The electronic device according to claim 11, wherein the another plurality of driving units further comprise:
another third driving unit group disposed adjacent to the another second driving unit group and comprising other 2P driving units, wherein the other 2P driving units respectively correspond to other P odd-numbered gate lines and other P even-numbered gate lines,
wherein a gate line corresponding to a driving unit at a position of the another second driving unit group is separated from a gate line corresponding to a driving unit at a corresponding position of the another third driving unit group by another (4P−1) gate lines.

14. The electronic device according to claim 13, wherein the another second driving unit group is located between the another first driving unit group and the another third driving unit group.

15. The electronic device according to claim 11, wherein the another plurality of driving units further comprise:
another last driving unit group, wherein the number of driving units comprised in the another last driving unit group is equal to the number of driving units comprised in the another first driving unit group.

16. The electronic device according to claim 15, wherein when all driving units in the another first driving unit group correspond to other odd-numbered gate lines, all driving units in the another last driving unit group correspond to other even-numbered gate lines.

17. The electronic device according to claim 15, when all driving units in the another first driving unit group correspond to other even-numbered gate lines, all driving units in the another last driving unit group correspond to other odd-numbered gate lines.

18. The electronic device according to claim 11, wherein the panel further comprises:
another redundant driving unit disposed in the second peripheral area,
wherein the another redundant driving unit is disposed between the another first driving unit group and the another second driving unit group or is disposed within the another first driving unit group.

19. The electronic device according to claim 1, wherein the display area comprises a display unit array having a half data line and double gate line (HDDG) configuration.

20. The electronic device according to claim 1, wherein clock signals received by the plurality of driving units have the same regularity
